(19) United States
(12) Patent Application Publication
(10) Pub. No.: US 2002/0163585 A1
(43) Pub. Date: Nov. 7, 2002

(54) Surveillance camera system and photographing lens system thereof

(75) Inventors: Hideto Machii, Saitama (JP); Takaaki Hashimoto, Kanagawa (JP); Kazunori Takahashi, Tokyo (JP); Junichi Fujisaki, Saitama (JP); Eijiroh Tada, Saitama (JP); Sachiko Nasu, Kanagawa (JP)

Correspondence Address: GREENBLUM & BERNSTEIN, P.L.C., 1941 ROLAND CLARKE PLACE, RESTON, VA, 20191, US

(73) Assignee: ASAHI SEIMITSU KABUSHIKI KAISHA, Tokyo (JP)

(21) Appl. No.: 10/073,105

(22) Filed: Feb. 12, 2002

(30) Foreign Application Priority Data
Feb. 23, 2001 (JP) 2001-48045 (P)

(51) Int. Cl. H04N 5/225

(52) U.S. Cl. 348/342; 348/335

(57) ABSTRACT

A surveillance camera system includes a photographing lens system, and a camera body to which the photographing lens system is detachably attached. The camera body includes a color imaging device on which an image formed by the photographing lens system is formed. The correcting of aberrations is carried out in a photographing lens system so that the difference between (1) the in-focus position at which the maximum MTF characteristic in the visible light wavelength range of about 400 nm to 700 nm is obtained and (ii) the in-focus position at which the maximum MTF characteristic in the near-infrared light wavelength range of about 700 nm to 1000 nm is obtained is less than 10μm.

### BACKGROUND OF THE INVENTION

1. Field of the Invention

The present invention relates to a surveillance camera system and a photographing lens system thereof, and in particular, relates to a surveillance camera system (day-and-night surveillance camera system) and a photographing lens system thereof which can be used in a visible light wavelength range (400˜700 nm) and a near-infrared light wavelength range (700˜1000 nm).

2. Description of the Prior Art

In the above-mentioned type of day-and-night surveillance camera system, color photography in the day time is performed by utilizing light in the visible light wavelength range to form an image onto a color imaging device (CCD) provided in a camera body; on the other hand, at night, monochrome photography is performed by utilizing light in the near-infrared light wavelength range in addition to light in the visible light wavelength range to form an image onto the color imaging device. The images formed on the color imaging device are displayed on a TV monitor. In this type of surveillance camera system, a mechanism for positioning a near-infrared light cut filter in front of the imaging device (in the camera body or in a lens barrel) in day-time photography, and for removing the near-infrared light cut filter therefrom in night photography is necessary.

With respect to the correcting of aberrations in a prior art photographing lens system, since the visible light wavelength range is considered to be more important, in design, than other wavelength ranges, a large defocus (a shift of an in-focus position) occurs in the near-infrared light wavelength range. Accordingly, in night photography, the near-infrared light cut filter is removed, and at the same time, for the purpose of aligning the in-focus position with the imaging surface of the imaging device, a transparent plane-parallel plate for adjusting the optical path length has to be inserted. The transparent plane-parallel plate is generally formed to have a predetermined thickness different from that of the near-infrared light cut filter. In addition to the function to cut near-infrared light, the transparent plane-parallel plate can also be provided with functions to cut near-infrared light, plane-parallel plates with filtering functions to cut visible light and ultraviolet light, and to control optical density and color temperatures and the like can also be provided.

In particular, in an interchangeable-lens type surveillance camera system having a photographing lens system and a camera body to which the photographing lens system is detachably attached, the amount of aberrations differs depending on an interchangeable photographing lens system. It is therefore necessary to prepare a plurality of near-infrared light cut filters of different thickness, and a plurality of transparent plane-parallel plates of different thickness, in accordance with the amount of aberrations in each interchangeable photographing lens system. Furthermore, a selected near-infrared light cut filter with a predetermined thickness and a selected transparent plane-parallel plate with a predetermined thickness have to be inserted in accordance with the type of a photographing lens system. As a result, a photographing lens system for a day-and-night surveillance camera system of the prior art requires a selecting-and-inserting/removing mechanism for the filters and the like having different thickness. However, such a mechanism inevitably makes the structure and control of the surveillance camera system complicated. In addition to the above, in a photographing lens system of the day-and-night surveillance camera system, there is a limitation that the camera system cannot be constituted unless the combination of a specific camera body and a specific photographing lens system is selected.

### SUMMARY OF THE INVENTION

An object of the present invention is to provide a surveillance camera system and a photographing lens system thereof, by which suitable photography can be performed in both the visible light wavelength range and the near-infrared light wavelength range.

Another object of the present invention is to provide a surveillance camera system and photographing lens system thereof, which do not require a complicated selecting-and-inserting/removing mechanism for the filters and the like.

The present invention is applied to a surveillance camera system including a photographing lens system and a camera body having a color imaging device on which an image by the photographing lens system is formed; and the photographing lens system is detachably attached on the camera body. According to the present invention, the photographing lens system itself is improved to have suitable optical performance for a day-and-night surveillance camera system, so that the number of the plane-parallel plates to be inserted in front of the color imaging device in the camera body can be reduced to two.

As an aspect of the present invention, the correcting of aberrations is carried out in a photographing lens system so that the difference between (i) the in-focus position at which the maximum MTF characteristic in the visible light wavelength range of about 400 nm to 700 nm is obtained and (ii) the in-focus position at which the maximum MTF characteristic in the near-infrared light wavelength range of about 700 nm to 1000 nm is obtained is less than 10 μm.

As another aspect of the present invention, a single near-infrared light cut filter and a single transparent plane-parallel plate are alternatively inserted in front of the color imaging device in the camera body or the photographing lens system. According to this arrangement, in day time photography, the near-infrared light cut filter is positioned in front of the color imaging device; on the other hand, in night photography, the transparent plane-parallel plate is positioned in front of the color imaging device. It is preferable that the product which multiplies the refractive index of the near-infrared light cut filter by the thickness thereof, i.e., the optical thickness, be the same as that of the transparent plane-parallel plate.

The present invention can particularly be applied to a camera system to which a plurality of interchangeable photographing lens systems are provided. For each of the interchangeable photographing lens systems, if aberrations are corrected so that the difference between (i) the in-focus position at which the maximum MTF characteristic in the visible light wavelength range of about 400 nm to 700 nm is obtained and (ii) the in-focus position at which the maximum MTF characteristic in the near-infrared light wavelength range of about 700 nm to 1000 nm is obtained is less than 10 μm, no optical adjustment is required even when another photographing lens system is attached to the camera body.

The present disclosure relates to subject matter contained in Japanese Patent Application No.2001-048045 (filed on Feb. 23, 2001) which is expressly incorporated herein in its entirety.

### BRIEF DESCRIPTION OF THE DRAWINGS

The present invention will be discussed below in detail with reference to the accompanying drawings, in which:

FIG. 1 shows a schematic view of an embodiment of a surveillance camera system according to the present invention;

FIG. 2 shows a schematic view of another embodiment of a surveillance camera system according to the present invention;

FIG. 3 shows curves of spectral distribution of a light-source;

FIG. 4 shows a curve of spectral sensitivity of a light-receiving element;

FIG. 5 shows a curve of spectral transmittance curve of a near-infrared light cut filter;

FIG. 6 shows a curve of the correcting of chromatic aberration, at the short focal length extremity, in a zoom photographing lens system according to the present invention;

FIG. 7 shows a curve of the correcting of chromatic aberration, at the long focal length extremity, in the zoom photographing lens system according to the present invention;

FIGS. 8A and 8B show MTF (modulation transfer function) curves, at the short focal length extremity, of the zoom photographing lens system of the present invention, in the visible light wavelength range and near-infrared light wavelength range, respectively;

FIGS. 9A and 9B show MTF curves, at the long focal length extremity, of the zoom photographing lens system of the present invention, in the visible light range and near-infrared light range, respectively;

FIG. 10 shows a curve of the correcting of chromatic aberration, at the short focal length extremity, in a zoom photographing lens system of a prior art;

FIG. 11 shows a curve of the correcting of chromatic aberration, at the long focal length extremity, in the zoom photographing lens system of a prior art;

FIGS. 12A and 12B show MTF curves, at the short focal length extremity, of the zoom photographing lens system of a prior art, in the visible light wavelength range and near-infrared light wavelength range, respectively; and

FIGS. 13A and 13B show MTF curves, at the long focal length extremity, of the zoom photographing lens system of a prior art, in the visible light wavelength range and near-infrared light wavelength range, respectively.

### DESCRIPTION OF THE PREFERRED EMBODIMENTS

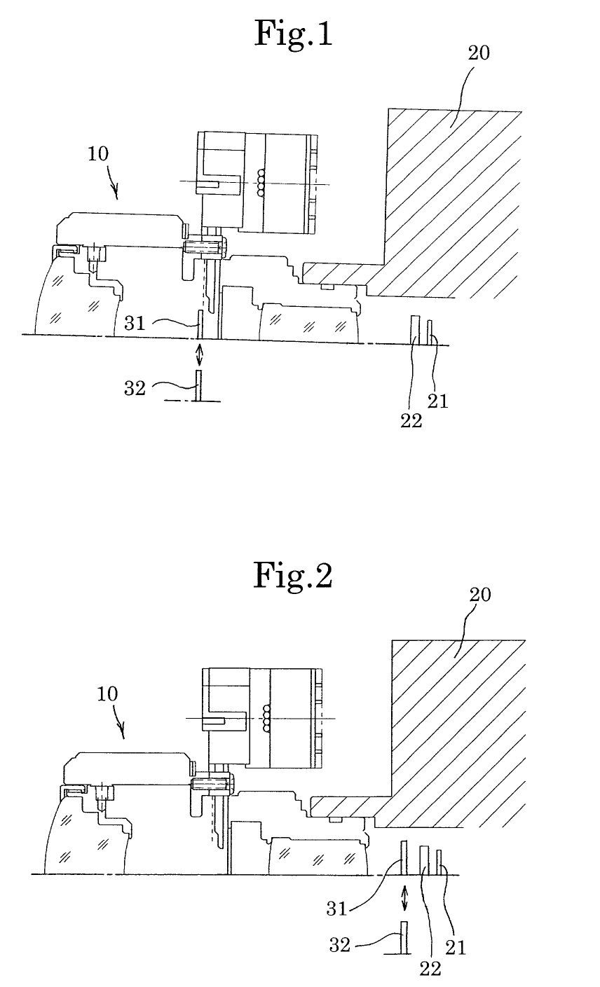

FIGS. 1 and 2 show the embodiments on a surveillance camera system. The surveillance camera system includes a zoom photographing lens system 10, and a camera body 20 to which the zoom photographing lens system 10 is detachably attached. In a predetermined stationary position in the camera body 20, a color imaging device (CCD) 21 on which an object image by the zoom photographing lens system 10 is formed is provided, and a low-pass filter 22 is positioned in front of the color imaging device 21.

In the zoom photographing lens system 10 (FIG. 1) or in the camera body 20 (FIG. 2), a near-infrared light cut filter 31 and a transparent plane-parallel plate 32, which are alternatively inserted in and retracted from the optical path, are provided. Since a selecting-and-inserting/removing mechanism for the filters is known in the art, such a mechanism is not shown in drawings. The product which multiplies the refractive index of the near-infrared light cut filter 31 by the thickness thereof, i.e., the optical thickness, is the same as that of the transparent plane-parallel plate 32.

In the zoom photographing lens system 10, the correcting of aberrations is carried out by taking the following into consideration: (i) the spectral sensitivity of the color imaging device 21; (ii) the spectral transmittance of the near-infrared-cut filter 31; and (iii) the light wavelength ranges of day light and night light.

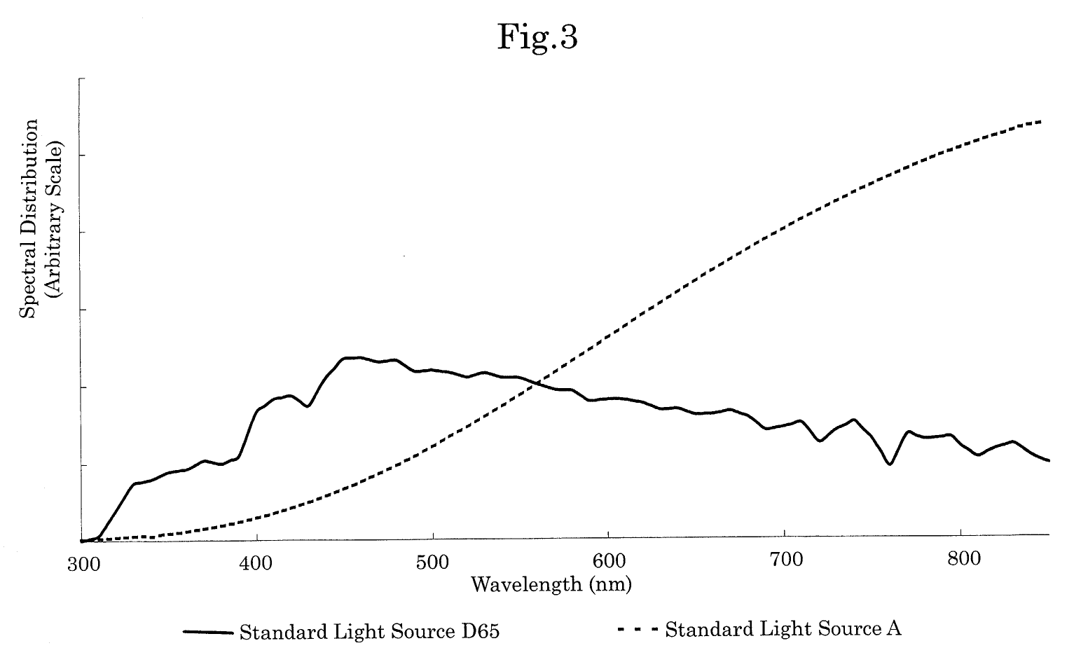

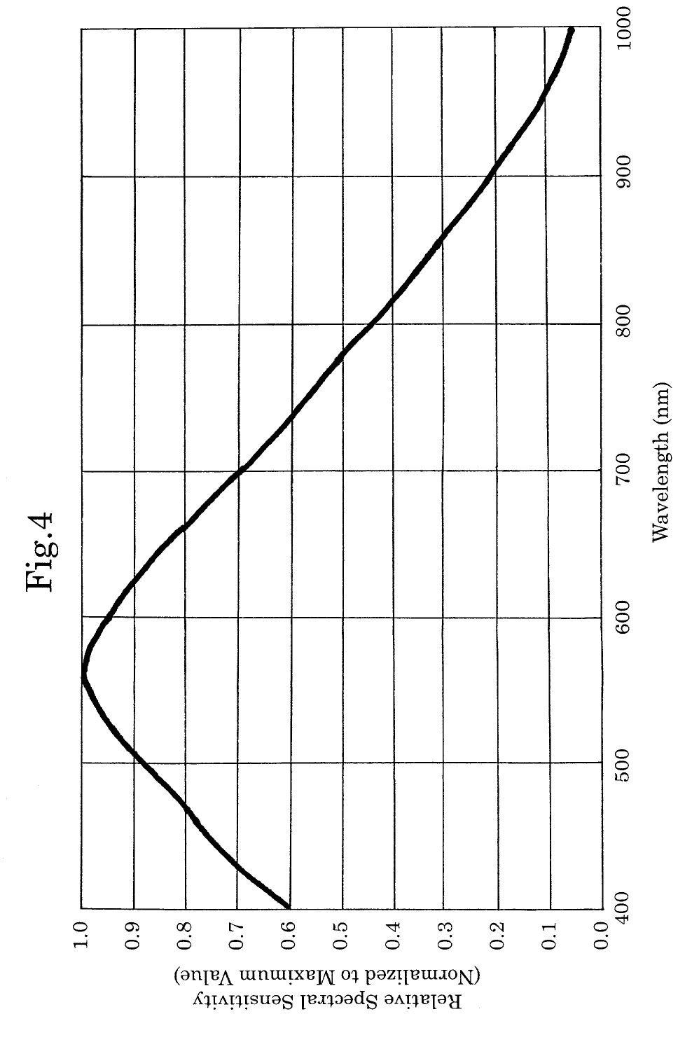

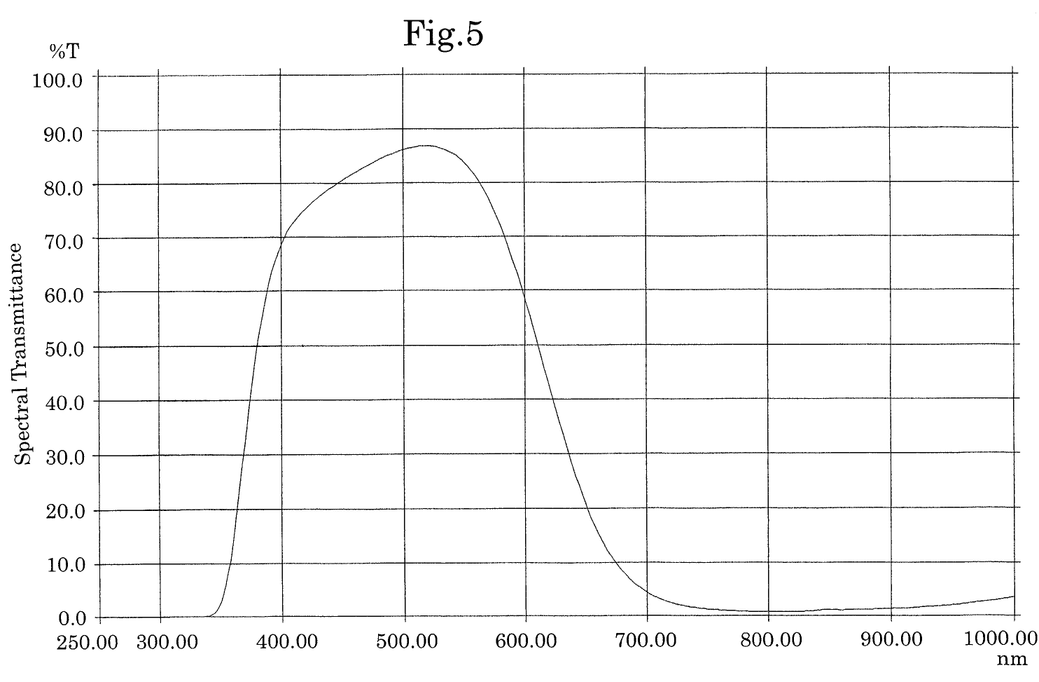

FIG. 3 shows the curves of spectral distribution of a light-source. The solid-line curve indicates the standard light source D65 as a light source for day light. On the other hand, the dotted-line curve indicates the standard light source A as a light source for night light. FIG. 4 shows the curve of spectral sensitivity of the color imaging device 21 (a light-receiving element). The spectral sensitivity is indicated as relative values so that the maximum value thereof is normalized to 1.0. FIG. 5 shows the curve of spectral transmittance of the near-infrared light cut filter 31.

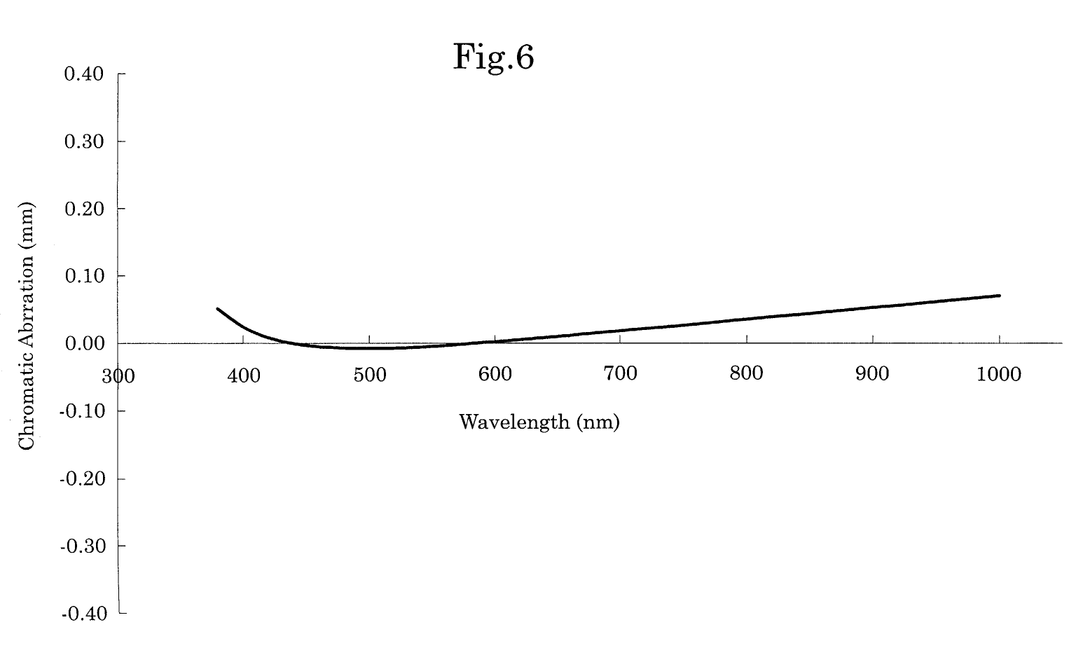

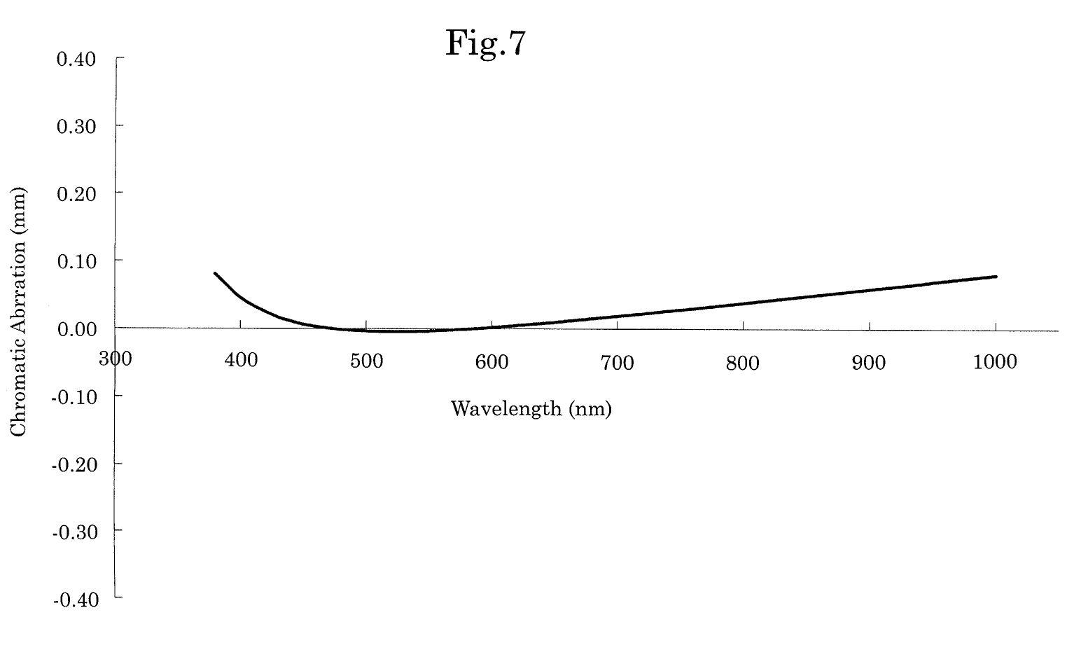

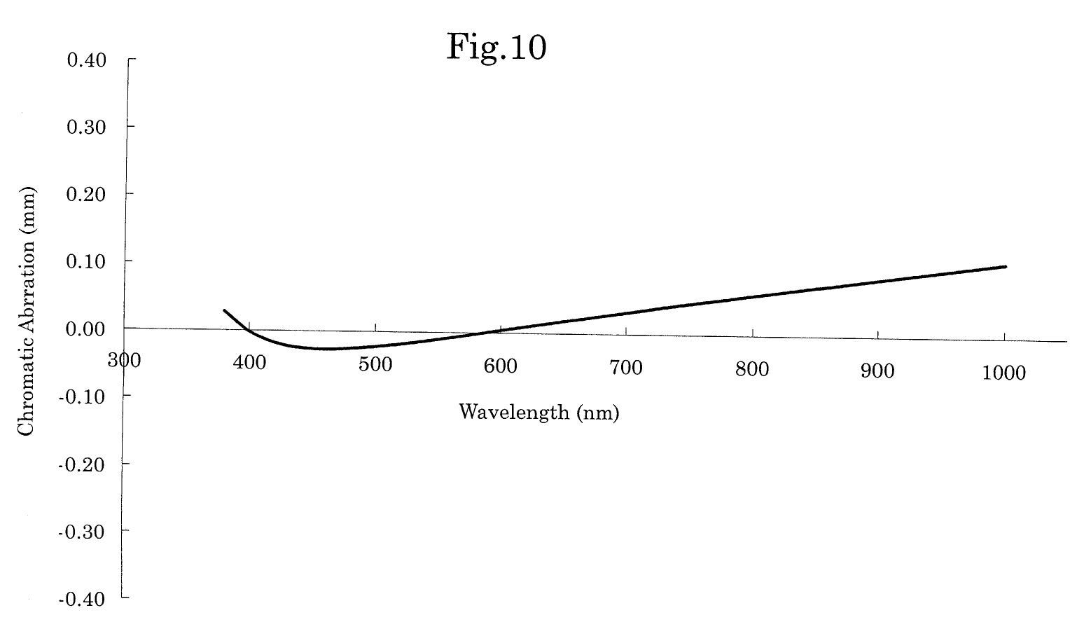

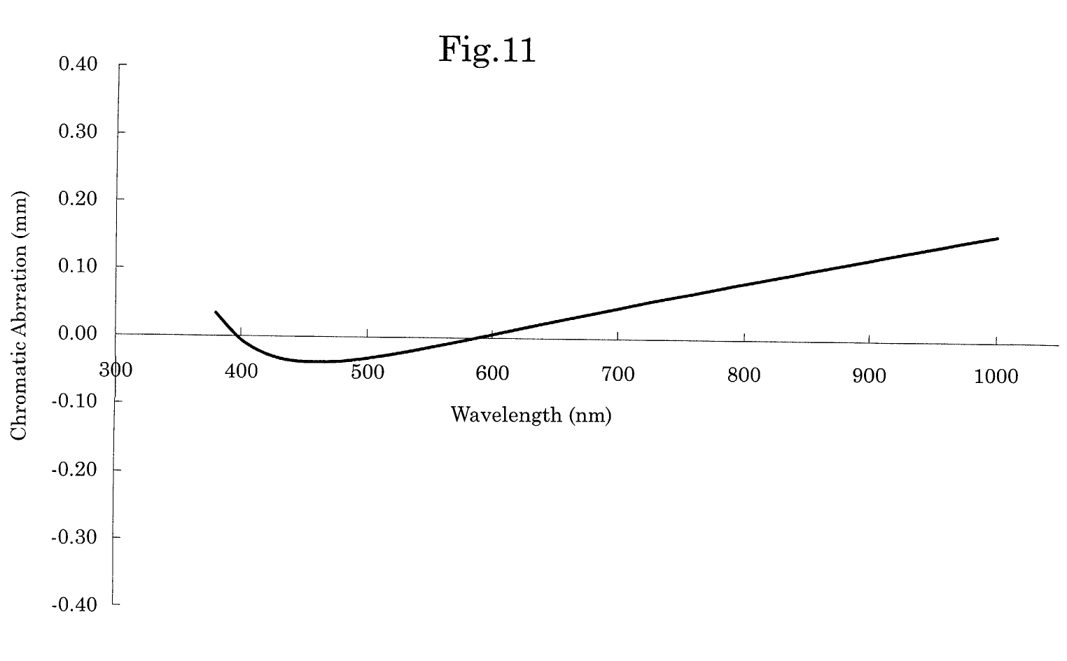

Chromatic aberration is the most important factor for determining the in-focus position in day light and night light. FIGS. 6 and 7 show chromatic-aberration characteristics of the zoom photographing lens system 10, at the short focal length extremity and the long focal length extremity. Furthermore, numerical data of the zoom photographing lens system 10 is indicated in Table 1. For the purpose of comparison, FIGS. 10 and 11 show chromatic- aberration characteristics of a prior art zoom photographing lens system, at the short focal length extremity and the long focal length extremity. Numerical data of the prior art zoom photographing lens system is indicated in Table 2. Note that the zoom photographing lens systems based on Tables 1 and 2 are both two-lens-group zoom photographing lens systems. Surface Nos. 18 and 19 designates the low-pass filter 22, F_{NO} designates the F-number, f designates the focal length of the entire lens system, W designates the half angle-of-view (°), f_{B} designates the back focal distance (the distance between surface No. 19 and the image surface of the color imaging device 21), r designates the radius of curvature, d designates the lens-element thickness or distance between lens elements, Nd designates the refractive index of the d-line, and ν designates the Abbe number.

TABLE 1

| | | F_{NO} = 1:1.4-1.9 | | |
|---|---|---|---|---|
| | | f = 2.88-5.82 | | |
| | | W = 68.9-33.2 | | |
| | | f_{B} = 5.22-9.76 | | |
| Surf. No. | r | d | N_{d} | ν |
| 1 | 26.608 | 1.000 | 1.77250 | 49.6 |
| 2 | 8.327 | 3.300 | — | — |
| 3 | 25.647 | 1.000 | 1.77250 | 49.6 |
| 4 | 10.447 | 2.050 | — | — |
| 5 | 102.077 | 1.000 | 1.72916 | 54.7 |
| 6 | 8.710 | 0.890 | — | — |
| 7 | 10.014 | 2.670 | 1.84666 | 23.8 |
| 8 | 29.920 | 19.68-5.52 | — | — |
| 9 | 50.000 | 1.800 | 1.83481 | 42.7 |
| 10 | −26.470 | 0.120 | — | — |
| 11 | 12.800 | 2.530 | 1.62041 | 60.3 |
| 12 | −27.500 | 0.430 | — | — |
| 13 | −15.780 | 5.610 | 1.69895 | 30.1 |
| 14 | 6.350 | 3.850 | 1.49700 | 81.6 |
| 15 | −12.450 | 0.100 | — | — |
| 16 | 37.468 | 1.500 | 1.74400 | 44.8 |
| 17 | −37.468 | 0.000 | — | — |
| 18 | ∞ | 3.500 | 1.49782 | 66.8 |
| 19 | ∞ | — | — | — |

TABLE 2

| | | F_{NO} = 1:1.4-1.8 | | |
|---|---|---|---|---|
| | | f = 2.86-5.85 | | |
| | | W = 68.3-32.9 | | |
| | | f_{B} = 5.21-9.78 | | |
| Surf. No. | r | d | N_{d} | ν |
| 1 | 26.608 | 1.000 | 1.77250 | 49.6 |
| 2 | 8.327 | 3.300 | — | — |
| 3 | 25.647 | 1.000 | 1.77250 | 49.6 |
| 4 | 10.447 | 2.050 | — | — |
| 5 | 102.077 | 1.000 | 1.72916 | 54.7 |
| 6 | 8.710 | 0.890 | — | — |
| 7 | 10.014 | 2.670 | 1.84666 | 23.8 |
| 8 | 29.920 | 19.81-5.54 | — | — |
| 9 | 53.304 | 2.000 | 1.83400 | 37.2 |
| 10 | −22.703 | 0.100 | — | — |
| 11 | 13.250 | 2.430 | 1.77250 | 49.6 |
| 12 | −70.608 | 0.460 | — | — |
| 13 | −19.850 | 5.360 | 1.80518 | 25.4 |
| 14 | 6.892 | 3.440 | 1.48749 | 70.2 |
| 15 | −13.800 | 0.100 | — | — |
| 16 | 154.400 | 1.860 | 1.89400 | 37.2 |
| 17 | −18.700 | 0.000 | — | — |
| 18 | ∞ | 3.500 | 1.49782 | 66.8 |
| 19 | ∞ | — | — | — |

In the prior-art zoom photographing lens system based on Table 2, at the short focal length extremity, as shown in FIG. 10, the correcting of aberrations is carried out so that in the visible light wavelength range, chromatic aberration becomes smaller in the range from 436 nm to 656 nm. On the contrary, in the near-infrared light wavelength range (700 nm-1000 nm), chromatic aberration largely increases. Furthermore, as can be understood by comparing the curve shown in FIG. 11 with that of FIG. 10, chromatic aberration becomes larger as the focal length increases. On the other hand, in the zoom photographing lens system 10 according to the embodiment of the present invention based on Table 1, as shown in FIG. 6, the correcting of aberration is carried out so that an increase of chromatic aberration in the near-infrared light wavelength range of 700 nm to 1000 nm becomes smaller with respect to chromatic aberration in the visible light wavelength range of 400 nm to 700 nm. Still further, as can be understood by comparing the curve shown in FIG. 7 with that of FIG. 6, chromatic aberration at the long focal length extremity is substantially the same as chromatic aberration at the short focal length extremity, even when the focal length increases.

An actual in-focus position is influenced not only by chromatic aberration, but also by other aberrations, e.g., spherical aberration. In addition, the actual in-focus position is influenced by the spectral sensitivity of the color imaging device 21, the spectral transmittance of the near-infrared light cut filter 31, and the light wavelength ranges of day light and night light. Therefore in order to obtain an in-focus position, the above-mentioned factors, such as the spectral sensitivity of the color imaging device 21 and the like, are weighed, and influence of each wavelength to an in-focus position is considered, thereby the MTF (modulation transfer function) curves are obtained. In other words, an axial MTF value is a specific value which is obtained based on aberrations, and all the characteristics shown in FIGS. 3 to 5, i.e., (i) the curves of spectral distribution of the light-source (FIG. 3); (ii) the curve of the spectral sensitivity of the color imaging device 21 (FIG. 4); (iii) the curve of the spectral transmittance of the near-infrared light cut filter 31 (FIG. 5); (iv) aberrations, specifically spherical aberration, occurred in lens elements of the zoom photographing lens system 10; and (v) chromatic aberration explained.

The in-focus position in the visible light wavelength range or the near-infrared light wavelength range can be defined as the maximum value of each MTF value.

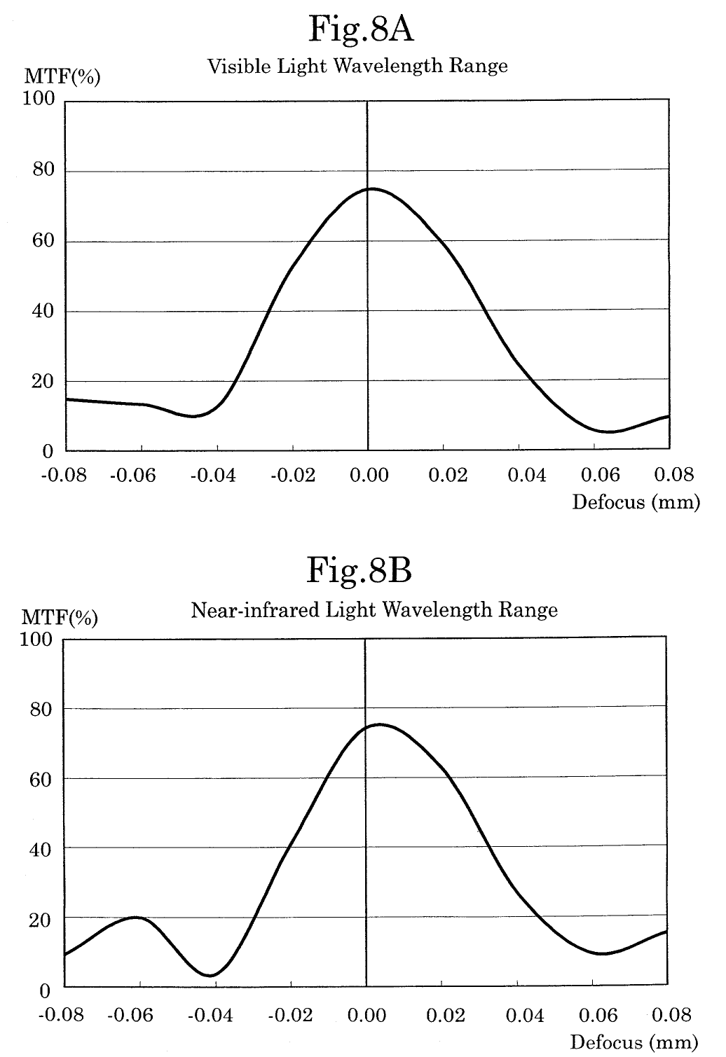

FIGS. 8A and 8B (MTF curves) show the defocus at the short focal length extremity, in the visible light wavelength range (FIG. 8A) and in the near-infrared light wavelength range (FIG. 8B), which is calculated by considering the characteristics obtained from FIGS. 3 to 5 with respect to the zoom photographing lens system 10 based on Table 1.

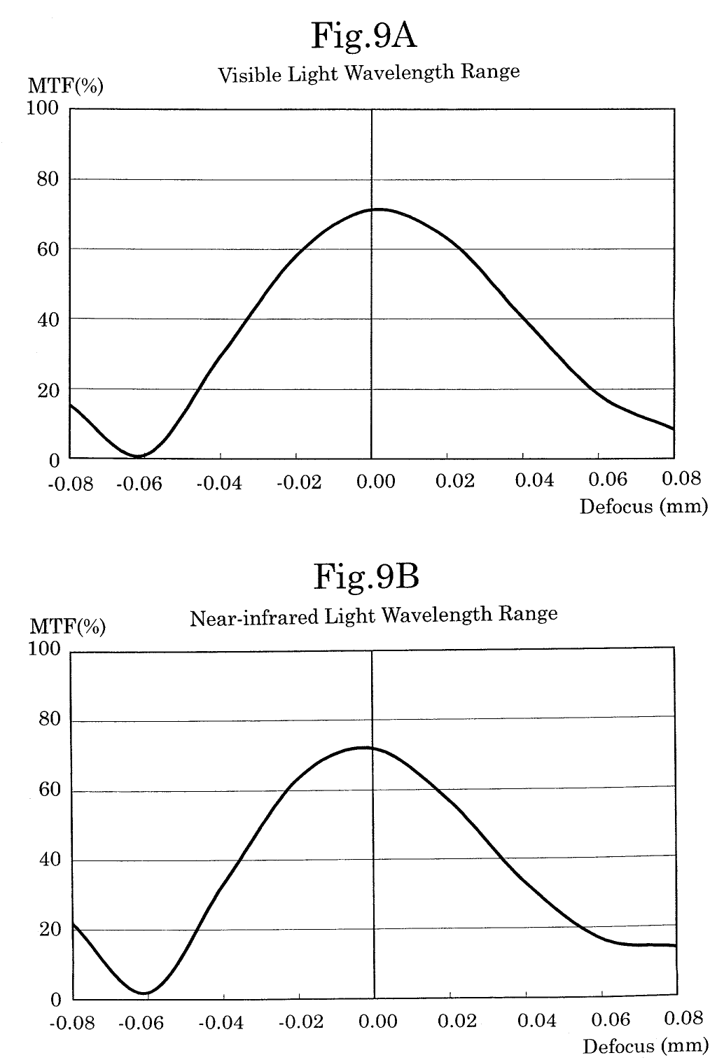

Similarly, FIGS. 9A and 9B (MTF curves) show the defocus at the long focal length extremity, in the visible light wavelength range (FIG. 9A) and in the near-infrared light wavelength range (FIG. 9B), which is calculated by considering the characteristics obtained from FIGS. 3 to 5 with respect to the zoom photographing lens system 10 based on Table 1.

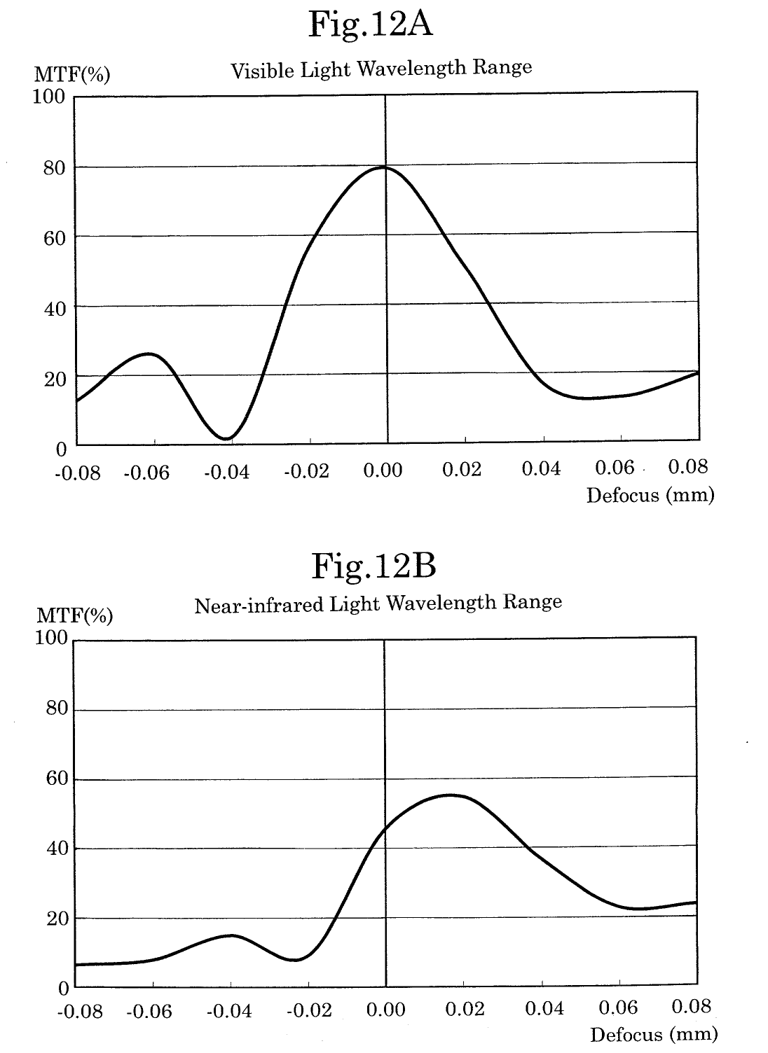

On the other hand, FIGS. 12A and 12B (MTF curves) show the defocus at the short focal length extremity, in the visible light wavelength range (FIG. 12A) and in the near-infrared light wavelength range (FIG. 12B), with respect to the zoom photographing lens system based on Table 2.

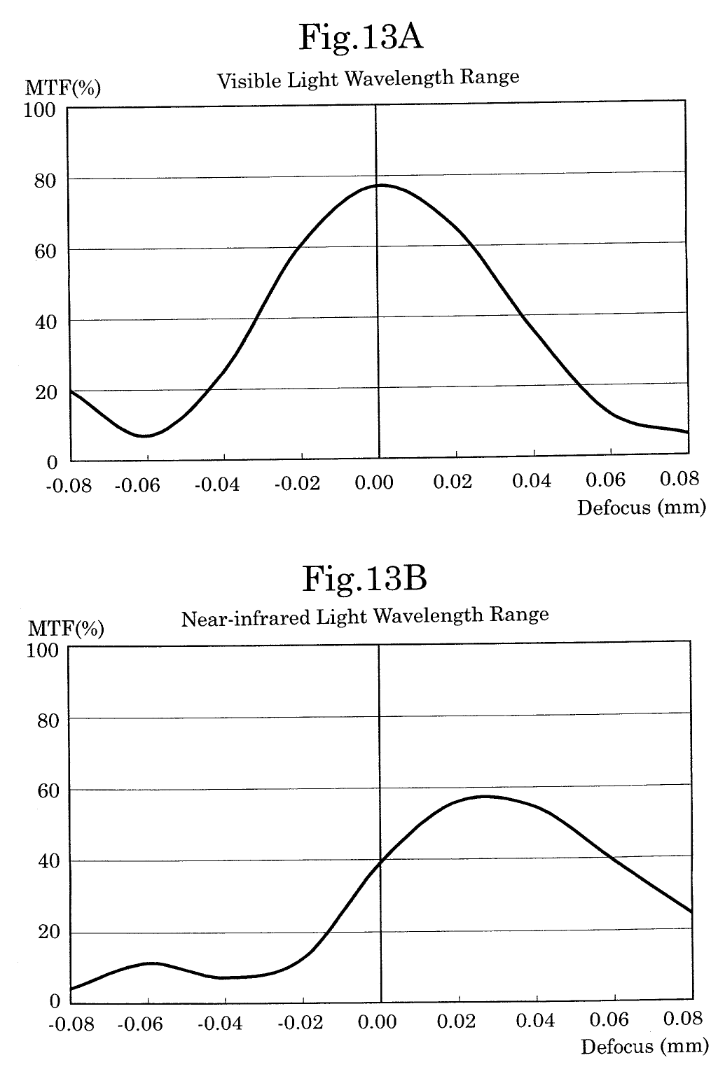

Similarly, FIGS. 13A and 13B (MTF curves) show the defocus at the long focal length extremity, in the visible light wavelength range (FIG. 13A) and in the near-infrared light wavelength range (FIG. 13B), with respect to the zoom photographing lens system based on Table 2.

In the above figures, sampling is carried out for wavelengths in both the visible light wavelength range and the near-infrared light wavelength range, and factors influencing the in-focus position are weighed according to the order of the magnitude of influence.

In FIGS. 8A, 8A, 9A, 9B, 12A, 12B, 13A and 13B, the in-focus position is the highest peak along the MTF curve. In comparison with FIGS. 12A through 13B of the prior art, the embodiments of FIGS. 8A through 9B can reduce the difference between the highest peak in the visible light wavelength range and the highest peak in the near-infrared light wavelength range to less than 10 μm. The allowance of 10 μm changes in accordance with the F-number, and the size of the light receiving element per pixel. For example, in a generally used photographing lens system having an F-number of 1.4, if the allowance is reduced to less than 10 μm, the decrease of the MTF value can be considered to be within an acceptable level. This can be understood from the above-mentioned figures. Namely, in these figures, the abscissa is calibrated every 20 μm (0.02 mm). If defocus is less than about half of 20 μm, the peak of the MTF curve is not lowered much.

In the embodiments of the zoom photographing lens system 10 shown in FIGS. 1 and 2, in daytime photography, the near-infrared light cut filter 31 is inserted into the optical path; on the other hand, in night photography, the transparent plane-parallel plate 32 is inserted into the optical path. Since the product which multiplies the refractive index of the near-infrared light cut filter 31 by the thickness thereof, i.e., the optical thickness, is the same as that of the transparent plane-parallel plate 32, the optical path length does not change even when either the near-infrared light cut filter 31 or the transparent plane-parallel plate 32 is inserted therein,

The above description is directed to the zoom photographing lens system 10; however, the present invention can be applied to a photographing lens system for a fixed-focus camera.

The embodiments are based on only one numerical data of Table 1; however, it is easy for those who are skilled in the art to design a photographing lens system having aberration characteristics (MTF characteristics), such as FIGS. 6 through 9B. In other words, a feature of the present invention does not reside in the design of a photographing lens system itself, but rather resides in utilizing a photographing lens system having aberration characteristics (MTF characteristics), such as FIGS. 6 through 9B, in a day-and-night surveillance camera system.

According to the above description, a surveillance camera system and a photographing lens system thereof, by which suitable photography can be performed in both the visible light wavelength range and the near-infrared light wavelength range, can be obtained.

Furthermore, a surveillance camera system and photographing lens system thereof, which do not require a complicated selecting-and-inserting/removing mechanism for the filters and the like, can be obtained.

What is claimed is:

1. A surveillance camera system comprising a photographing lens system, a camera body to which said photographing lens system is detachably attached, and in which a color imaging device on which an image formed by said photographing lens system is formed is provided;
wherein said photographing lens system is arranged to correct aberrations therein so that the difference between an in-focus position at which the maximum MTF characteristic in a visible light wavelength range of about 400 nm to 700 nm is obtained and an in-focus position at which the maximum MTF characteristic in a near-infrared light wavelength range of about 700 nm to 1000 nm is obtained is less than 10 μm.

2. The surveillance camera system according to claim 1, wherein said photographing lens system or said camera body comprises a single near-infrared light cut filter and a single transparent plane-parallel plate that are alternatively positioned in front of said color imaging device in said camera body,
wherein in day time photography, said near-infrared light cut filter is positioned in front of said color imaging device; and
wherein in night photography, said transparent plane-parallel plate is positioned in front of said color imaging device.

3. The surveillance camera system according to claim 2, wherein the product that multiplies the refractive index of said near-infrared light cut filter by the thickness thereof is the same as that of said transparent plane-parallel plate.

4. The surveillance camera system according to claim 1, wherein said surveillance camera system comprises a plurality of said photographing lens systems for said camera body; and
wherein each of said photographing lens systems is arranged to correct aberrations so that the difference between an in-focus position at which the maximum MTF characteristic in said visible light wavelength range of about 400 nm to 700 nm is obtained and an in-focus position at which the maximum MTF characteristic in said near-infrared light wavelength range of about 700 nm to 1000 nm is obtained is less than 10 μm.

5. A photographing lens system for a surveillance camera system, wherein said photographing lens system is detachably attached on a camera body that is provided with a color imaging device on which an object image formed; and
wherein said photographing lens system is arranged to correct aberrations so that the difference between an in-focus position at which the maximum MTF characteristic in a visible light wavelength range of about 400 nm to 700 nm is obtained and an in-focus position at which the maximum MTF characteristic in a near-infrared light wavelength range of about 700 nm to 1000 nm is obtained is less than 10 μm

6. The photographing lens system of a surveillance camera system according to claim 5, wherein said photographing lens system comprises a single near-infrared light cut filter and a single transparent plane-parallel plate that are alternatively positioned in front of said color imaging device in said camera body,
wherein in day time photography, said near-infrared light cut filter is positioned in front of said color imaging device; and
wherein in night photography, said transparent plane-parallel plate is positioned in front of said color imaging device.

7. The photographing lens system of a surveillance camera system according to claim 6, wherein the product that multiplies the refractive index of said near-infrared light cut filter by the thickness thereof is the same as that of said transparent plane-parallel plate.

8. The photographing lens system of a surveillance camera system according to claim 5, wherein a plurality of said photographing lens systems are provided for said camera body;
wherein each of said photographing lens systems is arranged to correct aberrations so that the difference between an in-focus position at which the maximum MTF characteristic in a visible light wavelength range of about 400 nm to 700 nm is obtained and an in-focus position at which the maximum MTF characteristic in the near-infrared light wavelength range of about 700 nm to 1000 nm is obtained is less than 10 μm.
